(19) United States
(12) Patent Application Publication
(10) Pub. No.: US 2026/0331032 A1
(43) Pub. Date: Oct. 22, 2026

(54) DISPLAY DEVICE

(71) Applicant: AUO Corporation, Hsinchu City (TW)

(72) Inventor: Yueh-Heng Lee, Hsinchu City (TW)

(73) Assignee: AUO Corporation, Hsinchu City (TW)

(21) Appl. No.: 19/333,281

(22) Filed: Sep. 18, 2025

(30) Foreign Application Priority Data
Apr. 21, 2025 (TW) 114114891

(51) Int. Cl. G09G 3/32

(52) U.S. Cl. CPC G09G 3/32; G09G 2320/0233; G09G 2320/0626; G09G 2380/10

(57) ABSTRACT

The disclosure provides a display device, including: multiple light-emitting elements, forming multiple columns of light-emitting elements extending along a direction, the columns of light-emitting elements comprising a first column light-emitting element and a second column light-emitting element adjacent to the first column light-emitting element and offset from each other along the direction by an offset distance, wherein the distance between the first column light-emitting element and the second column light-emitting element is a first pitch, wherein the spacing between two adjacent light-emitting elements of the first column light-emitting element is a second pitch; multiple pixel units, wherein each of the pixel units corresponds to each of the light-emitting elements, wherein the length of each of the pixel units along the direction is the second pitch, each of the pixel units along the direction is divided into n sub-pixel units, and the length of the sub-pixel unit is the offset distance.

### CROSS-REFERENCE TO RELATED APPLICATION

This application claims the priority benefit of Taiwan application serial no. 114114891 filed on Apr. 21, 2025. The entirety of the above-mentioned patent application is hereby incorporated by reference herein and made a part of this specification.

### BACKGROUND

### Technical Field

The disclosure relates to a display device.

### Description of Related Art

A special-shaped light-emitting diode (LED) display device is a type of LED display device with a special display shape. In contrast to the commonly seen rectangular LED display devices, the LED special-shaped display devices present a variety of shapes, offering diverse applications. For instance, they may be applied in automotive panoramic head-up displays (PHUDs) disposed at the bottom of a front glass of a vehicle to display vehicle information. However, due to the irregular shape of the special-shaped display devices, the LED light panels used for illumination cannot achieve a uniform display effect across the LED special-shaped display device, often resulting in vignetting at the boundaries of the special-shaped display device. Therefore, new technologies are required to address and improve the issue of vignetting in LED special-shaped display devices.

### SUMMARY

A display device for reducing vignetting caused by LED light panels at the boundaries of a special-shaped display device is provided in the disclosure.

A display device of the disclosure includes the following elements. Multiple light-emitting elements form multiple columns of light-emitting elements extending along a direction. The columns of light-emitting elements include a first column light-emitting element and a second column light-emitting element adjacent to the first column light-emitting element and offset from each other along the direction by an offset distance. A distance between the first column light-emitting element and the second column light-emitting element is a first pitch, a spacing between two adjacent light-emitting elements of the first column light-emitting element in the direction is a second pitch. Multiple pixel units in which each of the pixel units corresponds to each of the light-emitting elements. A length of each of the pixel units along the direction is the second pitch, each of the pixel units along the direction is divided into n sub-pixel units, and a length of the sub-pixel units along the direction is the offset distance.

Based on the above, by changing the arrangement of the light-emitting elements, the illumination effect of the adjacent special-shaped display device may be effectively improved.

### BRIEF DESCRIPTION OF THE DRAWINGS

FIG. 1 is a schematic diagram of a display device according to an embodiment of the disclosure.

FIG. 2A is a schematic diagram of a light-emitting element array according to an embodiment of the disclosure.

FIG. 2B is a schematic diagram of a dimming zone array according to an embodiment of the disclosure.

FIG. 3A is a schematic diagram of a light-emitting element array according to an embodiment of the disclosure.

FIG. 3B is a schematic diagram of a dimming zone array according to an embodiment of the disclosure.

FIG. 4A is a schematic diagram of a light-emitting element array according to an embodiment of the disclosure.

FIG. 4B is a schematic diagram of a dimming zone array according to an embodiment of the disclosure.

FIG. 5A is a schematic diagram of a light-emitting element array according to an embodiment of the disclosure.

FIG. 5B is a schematic diagram of a dimming zone array according to an embodiment of the disclosure.

### DETAILED DESCRIPTION OF DISCLOSED EMBODIMENTS

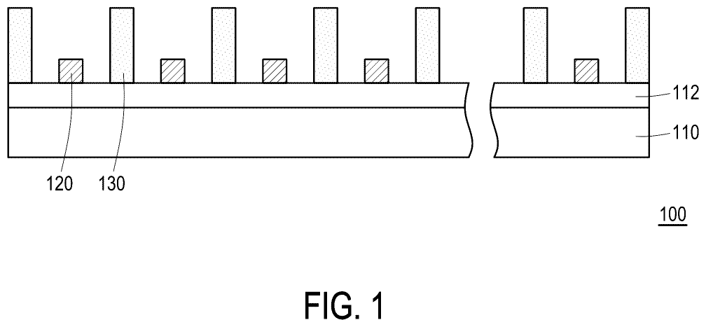

FIG. 1 is a schematic diagram of a display device according to an embodiment of the disclosure. Referring to FIG. 1, a display device 100 includes a substrate 110, a control circuit 112, light-emitting elements 120, and light-shielding layers 130.

The substrate 110 serves as a carrier layer of the display device 100. In some embodiments, the substrate 110 may be a light-transmissive or non-light-transmissive material. In some embodiments, the material of the substrate 110 includes glass, quartz, sapphire, or the like, but the disclosure is not limited thereto.

The control circuit 112 is disposed on the substrate 110. In some embodiments, the control circuit 112 includes interleaved signal lines, multiple active element (e.g., thin film transistors), and a control circuit.

The light-emitting elements 120 are disposed on the control circuit 112 and are electrically connected to the control circuit 112. Multiple light-shielding layers 130 are included between the light-emitting elements 120 to define multiple pixel units. In some embodiments, a pixel unit includes a light-emitting element 120, at least one active element in a control circuit 112, and a signal line, in which the signal line is configured to control the on/off state of the light-emitting element 120. In some embodiments, the light-emitting elements 120 are arranged in a two-dimensional array on the control circuit 112.

In some embodiments, in terms of size, the light-emitting element 120 may be a light-emitting diode, a micro light-emitting diode (micro LED), etc., but the disclosure is not limited thereto. In terms of light-emitting wavelength, the light-emitting element may emit blue light, red light, green light, infrared light, ultraviolet light, or a combination thereof, but the disclosure is not limited thereto.

When the light-emitting elements 120 are driven by the control circuit 112, each light-emitting element 120 may be turned on or off respectively to meet the local lighting requirements of the display device, thereby achieving a local dimming effect.

The light-shielding layer 130 is disposed on the control circuit 112 and is located between the light-emitting elements 120 to prevent adjacent light-emitting elements 120 from interfering with each other and causing light mixing. In addition, the sidewalls of the light-shielding layer 130 may have a reflective material to concentrate the light emitted by the light-emitting element 120. Therefore, the light-shielding layers 130 on the two sides of the light-emitting element 120 are configured to define a pixel unit and form a cavity corresponding to the pixel unit.

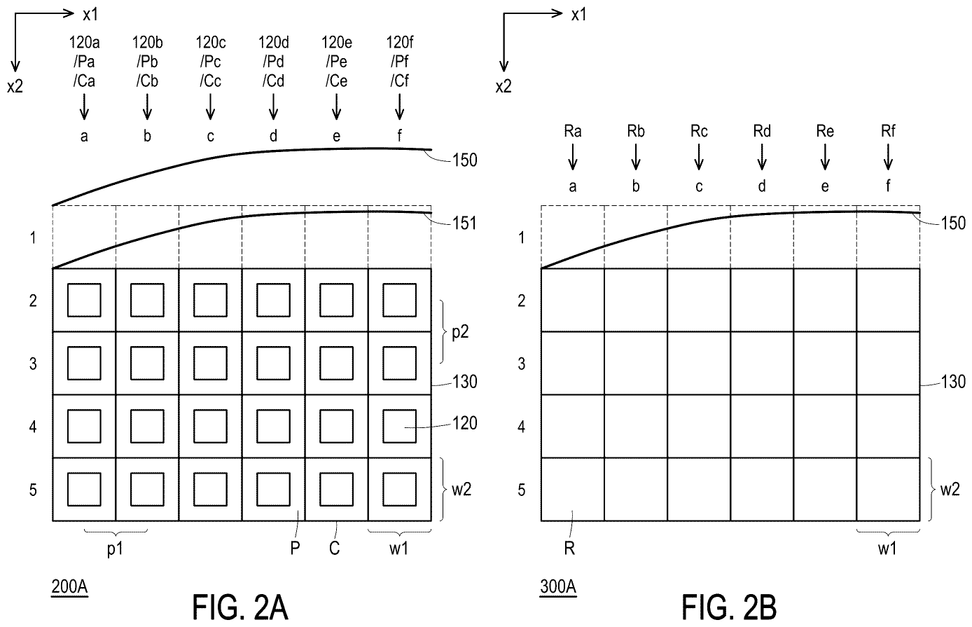

FIG. 2A is a schematic diagram of a light-emitting element array according to an embodiment of the disclosure. Referring to FIG. 2A, FIG. 2A shows a portion of a light-emitting element array in a display device, including multiple light-emitting elements 120, a boundary 151 of the display device, and a front glass 150. In this embodiment, the display device of this embodiment is used as a head-up display, and the front glass 150 is used as a projection surface. The head-up display includes a boundary 151 having a curvature. In the context of automotive applications, the head-up display is disposed at the bottom of the front glass 150 of the vehicle body. Therefore, the boundary 151 of the head-up display needs to be curved to match the curvature of the front glass 150 to reduce the extent of de-warping required for the display. Specifically, FIG. 2A shows a situation where the arrangement of the light-emitting element array is not adjusted according to the shape of the front glass 150.

As shown in FIG. 2A, the light-emitting element array 200A includes multiple light-emitting elements 120. The light-emitting elements 120 are arranged in a two-dimensional array. For ease of description, as shown in FIG. 2A, the position of the light-emitting elements 120 are described in coordinate form, in which the coordinates in the first direction x1 are sequentially a, b, c . . . and the coordinates in the second direction x2 are sequentially 1, 2, 3 . . .

As shown in FIG. 2A, the light-emitting elements 120 form multiple columns of light-emitting elements extending along the second direction x2, such as an a^{th} column one-dimensional light-emitting element array with a coordinate of a in the first direction; a b^{th} column one-dimensional light-emitting element array with a coordinate of b in the first direction, and so on. In this embodiment, without loss of generality, the a^{th} column one-dimensional light-emitting element array is selected to be referred to as the first column light-emitting element 120a, and the b^{th} column one-dimensional light-emitting element array adjacent to the first column light-emitting element is selected to be referred to as the second column light-emitting element 120b.

As shown in FIG. 2A, the distance between the first column light-emitting element 120a and the second column light-emitting element 120b in the first direction x1 is a first pitch p1. The first pitch p1 is the distance between the centers of any light-emitting element in the first column light-emitting element 120a (e.g., the light-emitting element located at (a, 2)) and the corresponding light-emitting element in the second column light-emitting element 120b (i.e., the adjacent column of the first column light-emitting element 120a) (e.g., the light-emitting element located at (b, 2)) along the first direction x1. In this embodiment, the distance between each column light-emitting element and the adjacent column light-emitting element in the first direction x1 is the first pitch p1.

As shown in FIG. 2A, a spacing between two adjacent light-emitting elements 120 in the first column light-emitting element 120a in the second direction x2 is a second pitch p2. The second pitch p2 is the spacing between the centers of any light-emitting element in the first column (e.g., the light-emitting element at (a, 2)) and its adjacent light-emitting element in the same column (e.g., the light-emitting element at (a, 3)) along the second direction x2. In this embodiment, the spacing between any two adjacent light-emitting elements in the second direction x2 is the second pitch p2.

In some embodiments, the first pitch p1 is greater than the second pitch p2.

In some embodiments, the first pitch p1 is 8.5 mm, and the second pitch p2 is 8.2 mm. However, in other embodiments, the first pitch p1 and the second pitch p2 may also be other values, and the disclosure is not limited thereto.

In some embodiments, the first pitch p1 is equal to the second pitch p2. In some other embodiments, the first pitch p1 is not equal to the second pitch p2.

As shown in FIG. 2A, the light-emitting element array 200A further includes multiple pixel units P, each of the pixel units P corresponds to each of the light-emitting elements 120. In some embodiments, one pixel unit P may correspond to one or more pixels, and the disclosure is not limited thereto. Taking the light-emitting element 120 located at the coordinates (a, 2) as an example, the corresponding pixel unit P is the pixel unit in the region of the coordinates (a, 2). In this embodiment, all pixel units P have the same size. A length w1 of each pixel unit P along the first direction x1 is the first pitch p1, and a length w2 of each pixel unit P along the second direction x2 is the second pitch p2.

In addition, the pixel units corresponding to the a^{th} column one-dimensional light-emitting element array 120a are referred to as the first column pixel unit Pa, and the pixel units corresponding to the b^{th} column one-dimensional light-emitting element array 120b are referred to as the second column pixel unit Pb.

As shown in FIG. 2A, the light-emitting element array 200A further includes multiple cavities C, in which each cavity C corresponds to each of the light-emitting elements 120. In this embodiment, since each light-emitting element 120 corresponds to a pixel unit P, each of the cavities C also corresponds to each of the pixel units P respectively.

Taking the light-emitting element 120 located at the coordinates (a, 2) as an example, the corresponding cavity C is the cavity in the region with the coordinates (a, 2), that is, the region surrounded by the light-shielding layer 130. Since each cavity C corresponds to a light-emitting element 120 and a pixel unit P, the light emitted by each light-emitting element 120/pixel unit P may be separated from the adjacent light-emitting element 120/pixel unit P.

In this embodiment, all cavities C have the same size. A length w1 of each of the cavities C along the first direction x1 is the first pitch p1, and a length w2 of each of the cavities C along the second direction x2 is the second pitch p2. The four sidewalls of the cavity C are formed by the light-shielding layer 130.

Therefore, the size of the cavity C is the same as the size of the pixel unit P.

In addition, the cavities corresponding to the a^{th} column one-dimensional light-emitting element array 120a are referred to as the first column cavity Ca, and the cavities corresponding to the b^{th} column one-dimensional light-emitting element array 120b are referred to as the second column cavity Cb.

FIG. 2B is a schematic diagram of a dimming zone array according to an embodiment of the disclosure. Referring to FIG. 2A and FIG. 2B at the same time, the dimming zone array 300A shown in FIG. 2B corresponds to the light-emitting element array 200A shown in FIG. 2A.

The dimming zone array 300A and the light-emitting element array 200A have the same checkerboard arrangement. The dimming zone array 300A includes multiple dimming zones R, each of the dimming zones R corresponds to each of the light-emitting elements 120 in the light-emitting element array 200A in FIG. 2A. In this embodiment, since each light-emitting element 120 corresponds to a pixel unit P, each of the dimming zones R also corresponds to each of the pixel units P respectively.

For example, the dimming zone array 300A is located at the dimming zone R at the coordinates (a, 2), corresponding to the light-emitting element 120 located at the coordinates (a, 2) and the pixel unit P located at the coordinates (a, 2) in the light-emitting element array 200A.

Therefore, the control circuit 112 shown in FIG. 1, by being electrically connected to the light-emitting elements 120, is configured to control the light-emitting states of the light-emitting elements 120, thereby controlling the brightness of the dimming zones R to achieve a local dimming effect.

As shown in FIG. 2B, a length w1 of each dimming zone R along the first direction x1 is the first pitch p1, and a length w2 of each dimming zone R along the second direction x2 is the second pitch p2.

Therefore, the size of the dimming zone R is the same as the size of the pixel unit P.

In addition, the dimming zones corresponding to the a^{th} column one-dimensional light-emitting element array 120a are referred to as the first column dimming zone Ra, and the dimming zones corresponding to the b^{th} column one-dimensional light-emitting element array 120b are referred to as the second column dimming zone Rb.

Therefore, as shown in FIG. 2A and FIG. 2B, each light-emitting element 120 corresponds to a pixel unit P, a cavity C, and a dimming zone R. In addition, each of the pixel unit P, the cavity C, and the dimming zone R has the same size.

However, in the scenarios shown in FIG. 2A and FIG. 2B, since the boundary 151 extends approximately within the region between coordinates (a, 1) and (f, 1), there are no light-emitting elements 120 in this region, resulting in limited illumination efficiency close to the boundary 151 and causing defects such as vignetting.

The following describes a method for improving the illumination effect near the boundary 151 by changing the arrangement of the light-emitting elements 120.

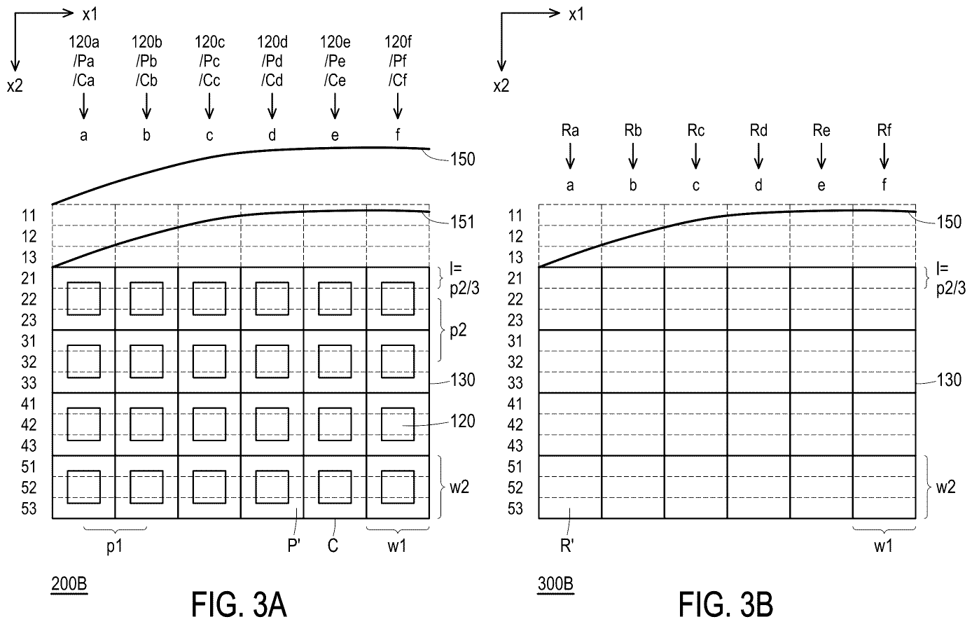

FIG. 3A is a schematic diagram of a light-emitting element array according to an embodiment of the disclosure. FIG. 3B is a schematic diagram of a dimming zone array according to an embodiment of the disclosure.

Referring to FIG. 3A first, in order to enable the light-emitting elements 120 to be closer to the boundary 151, the arrangement of the light-emitting element array 200A in FIG. 2A is adjusted as follows to become the light-emitting element array 200B in FIG. 3A.

As shown in the light-emitting element array 200B, first, the coordinate of the light-emitting element array in the second direction x2 is divided into n equal parts. Therefore, the second direction x2 may be divided into smaller units. In some embodiments, n is a positive integer greater than or equal to 2. The value of n is usually inversely related with the dimension of the display device in the second direction x2. For example, if the dimension of the display device in the second direction x2 increases, a smaller value of n, such as 2 or 3, is selected. On the contrary, if the dimension of the display device in the second direction x2 decreases, a larger value of n, such as a positive integer greater than or equal to 4, may be selected. In some embodiments, n is less than or equal to 5, but not limited thereto. By setting n to be less than or equal to 5, the resultant unit length after division may be prevented from becoming excessively fine. Specifically, if the number of divisions is too high, the control circuit that controls the dimming zone (e.g., the local dimming IC) will have more partitions, often requiring customization, and the number of driver circuit ICs will also increase, significantly increasing costs.

In this embodiment, the unit length in the second direction is divided into three equal parts, that is, n is equal to 3. Taking the pixel unit P with the original coordinates (a, 1) as an example, the division results in three sub-pixel units P′ at (a, 11), (a, 12), and (a, 13). The remaining pixel units are also divided in a similar manner.

Therefore, the length of each divided sub-pixel unit P′ in the first direction x1 is still the first pitch p1. The length l in the second direction x2 is one third of the second pitch p2, that is, l=p2/3.

Therefore, after division, each light-emitting element 120 and its corresponding pixel unit P correspond to three sub-pixel units P′.

Since each of the cavities C corresponds to each of the light-emitting elements 120 and corresponds to each of the pixel units P, therefore, each cavity C also corresponds to three sub-pixel units P′.

Referring to FIG. 3B, the arrangement of the dimming zone array 300A in FIG. 2B is adjusted as follows to become the dimming zone array 300B in FIG. 3B. According to a method similar to that of FIG. 3A, each dimming zone R of the dimming zone array 300B is also divided in the same manner, and each dimming zone is divided into three dimming sub-zones R′.

The length of each divided dimming sub-zone R′ in the first direction x1 is still the first pitch p1. The length l in the second direction x2 is one third of the second pitch p2, that is, l=p2/3.

Since each of the dimming zones R corresponds to each of the light-emitting elements 120 and corresponds to each of the pixel units P, therefore, each dimming zone R also corresponds to three sub-pixel units P′.

In addition, each sub-pixel unit P′ of the light-emitting element array 200B in FIG. 3A also corresponds to a dimming sub-zone R′ of the dimming zone array 300B in FIG. 3B. For example, the sub-pixel unit P′ with coordinates (a, 11) corresponds to the dimming sub-zone R′ with coordinates (a, 11).

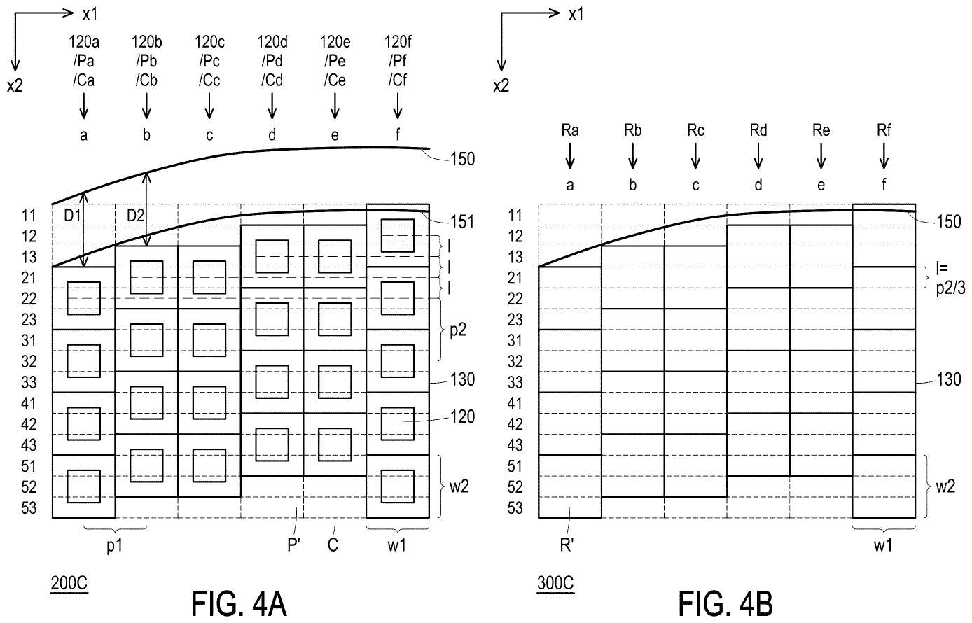

Then, the configuration of the light-emitting element 120 and its corresponding pixel unit P, cavity C, and dimming zone R is adjusted. The specific method is shown in FIG. 4A and FIG. 4B.

FIG. 4A is a schematic diagram of a light-emitting element array according to an embodiment of the disclosure. FIG. 4B is a schematic diagram of a dimming zone array according to an embodiment of the disclosure.

Referring to FIG. 4A first, in order to enable the light-emitting elements 120 to be closer to the boundary 151, the arrangement of the light-emitting element array 200B in FIG. 3A is adjusted as follows to become the light-emitting element array 200C in FIG. 4A.

Without loss of generality, the following description is made with reference to the first column light-emitting element 120a and the second column light-emitting element 120b.

The first column light-emitting element 120a and the second column light-emitting element 120b are offset from each other along the second direction x2 by an offset distance l. The offset distance l is the length l of the sub-pixel unit P′ along the second direction x2. Specifically, the relationship between the offset distance l and the second pitch p2 is expressed as l=p2/n, where l is the offset distance, p2 is the second pitch, and n is a positive integer greater than or equal to 2.

Taking the light-emitting element array 200C of FIG. 4A as an example, first, the positions of the light-emitting elements 120 in the first column light-emitting element 120a (e.g., the light-emitting elements with a coordinate of a in the first direction x1) are fixed.

Next, the light-emitting elements 120 in the second column light-emitting element 120b (e.g., the light-emitting elements with a coordinate of b in the first direction x1) are moved upward along the second direction x2 by an offset distance l. In this embodiment, n=3, and the offset distance l is the length l of each sub-pixel unit along the second direction x2 in FIG. 3A, where l=p2/3, as shown in FIG. 4A.

Taking the first light-emitting element in the second column light-emitting element 120b as an example, its coordinates before movement are (b, 22), and its coordinates after movement become (b, 21). This indicates a shift of one offset distance l along the second direction x2, which corresponds to the length of one sub-pixel unit P′ along the second direction x2. The remaining elements follow accordingly.

As shown in FIG. 3A, each light-emitting element 120 corresponds to one pixel unit P, that is, corresponds to three sub-pixel units P′. Therefore, taking the first light-emitting element in the second column light-emitting element 120b as an example, the coordinates of the position before movement are (b, 22), and the corresponding pixel unit P includes sub-pixel units located at (b, 21), (b, 22), and (b, 23). The coordinates of the position after movement become (b, 21), so the new pixel unit P corresponding to the light-emitting element includes sub-pixel units located at (b, 13), (b, 21), and (b, 22).

On the other hand, the first light-emitting element of the first column light-emitting element 120a has the coordinates of (a, 22), and its corresponding pixel unit P includes sub-pixel units located at (a, 21), (a, 22), and (a, 23).

Therefore, relative to the pixel unit corresponding to the first light-emitting element located at (a, 22) of the first column light-emitting element 120a, the pixel unit corresponding to the first light-emitting element located at (b, 21) of the second column light-emitting element 120b is offset along the second direction x2 by an offset distance l or offset by a sub-pixel unit P′.

Furthermore, in this embodiment, the display device is adapted to a transportation vehicle, which includes a curved front glass 150. The display device of this embodiment is used as a head-up display, and the front glass 150 is used as a projection surface. As shown in FIG. 4A, the front glass 150 includes a curved boundary, and the head-up display includes a curved boundary 151, which matches the boundary of the front glass 150. In the context of automotive applications, the head-up display is disposed at the bottom of the front glass 150. Therefore, the boundary 151 of the head-up display needs to be curved to match the curvature of the front glass 150 to reduce the extent of de-warping required for the display.

As shown in FIG. 4A, the distance between the midpoint of a side of the first column light-emitting element 120a facing the boundary 151 and the boundary of the front glass 150 along the second direction x2 is defined as a first distance D1, and the distance between the midpoint of a side of the second column light-emitting element 120b facing the boundary 151 and the boundary of the front glass 150 along the second direction x2 is defined as a second distance D2. The second distance D2 has a difference with the first distance D1, and the difference is less than or equal to the offset distance l. Consequently, the second column light-emitting element 120b after movement is closer to the boundary of the front glass 150 in the second direction x2, so that the light-emitting elements may better fit the curvature of the front glass 150, which is equivalent to better fitting the curvature of the front glass in the context of automotive applications.

As a result, the second column light-emitting element 120b after movement is closer to the front glass 150 in the second direction x2, thus achieving a better illumination effect.

As mentioned above, each of the cavities C corresponds to each of the pixel units P, and each of the cavities C also corresponds to three sub-pixel units P′.

Therefore, relative to the cavity C corresponding to the first pixel unit located at (a, 22) of the first column pixel unit Pa, the cavity C corresponding to the first pixel unit located at (b, 21) of the second column pixel unit Pb is offset along the second direction x2 by an offset distance l, that is, one sub-pixel unit P′.

The remaining columns of light-emitting elements are adjusted according to a similar method. The third column light-emitting element 120c is not offset relative to the second column light-emitting element 120b. The fourth column light-emitting element 120d is offset from the third column light-emitting element 120c by an offset distance l. The fifth column light-emitting element 120e is not offset relative to the fourth column light-emitting element 120d. The sixth column light-emitting element 120f is offset from the fifth column light-emitting element 120e by an offset distance l.

Therefore, the third column pixel unit Pc is not offset relative to the second column pixel unit Pb. The fourth column pixel unit Pd is offset from the third column pixel unit Pc by one sub-pixel unit P′. The fifth column pixel unit Pe is not offset relative to the fourth column pixel unit Pd. The sixth column pixel unit Pf is offset from the fifth column pixel unit Pe by one sub-pixel unit P.

Referring to FIG. 4B, in correspondence with the movement of the light-emitting element array 200C in FIG. 4A, the arrangement of the dimming zone array 300B in FIG. 3B is adjusted as follows to become the dimming zone array 300D in FIG. 4B.

As shown in FIG. 4B, each dimming zone R corresponds to a pixel unit P, and the three dimming sub-zones R′ of the dimming zone R correspond to the three sub-pixel units P′ of the pixel unit P.

Therefore, the first pixel unit of the first column pixel unit Pa has the coordinates of (a, 22) and includes sub-pixel units P′ located at (a, 21), (a, 22), and (a, 23). The corresponding dimming zone R includes dimming sub-zones R′ located at (a, 21), (a, 22), and (a, 23).

On the other hand, the coordinates of the position of the first pixel unit of the second column pixel unit Pb before movement are (b, 22), and the first pixel unit includes sub-pixel units located at (b, 21), (b, 22), and (b, 23). The coordinates of the position after movement become (b, 21), so the new pixel unit P corresponding to the pixel unit includes sub-pixel units located at (b, 13), (b, 21), and (b, 22). The corresponding dimming zone R includes dimming sub-zones R′ located at (b, 13), (b, 21), and (b, 22).

Therefore, relative to the dimming zone R corresponding to the first pixel unit P located at (a, 22) of the first column pixel unit Pa, the dimming zone R corresponding to the first pixel unit P located at (b, 21) of the second column pixel unit Pb is offset along the second direction x2 by an offset distance l or offset by a dimming sub-zone R′.

As shown in FIG. 4A and FIG. 4B, by changing the position of the light-emitting element 120 in the second direction x2 and adjusting the configuration of the corresponding pixel unit P, cavity C, and dimming zone R accordingly, the light-emitting element 120 may be arranged closer to the boundary 151, thereby improving the illumination effect near the boundary 151 and reducing the occurrence of vignetting and the like.

On the other hand, since the current control circuit 112 supports a checkerboard configuration of dimming zones, by dividing the dimming zone into multiple dimming sub-zones and reassembling them into dimming zones corresponding to the light-emitting elements after movement, the control circuit 112 may be adapted to the new dimming zones, thereby enhancing user convenience.

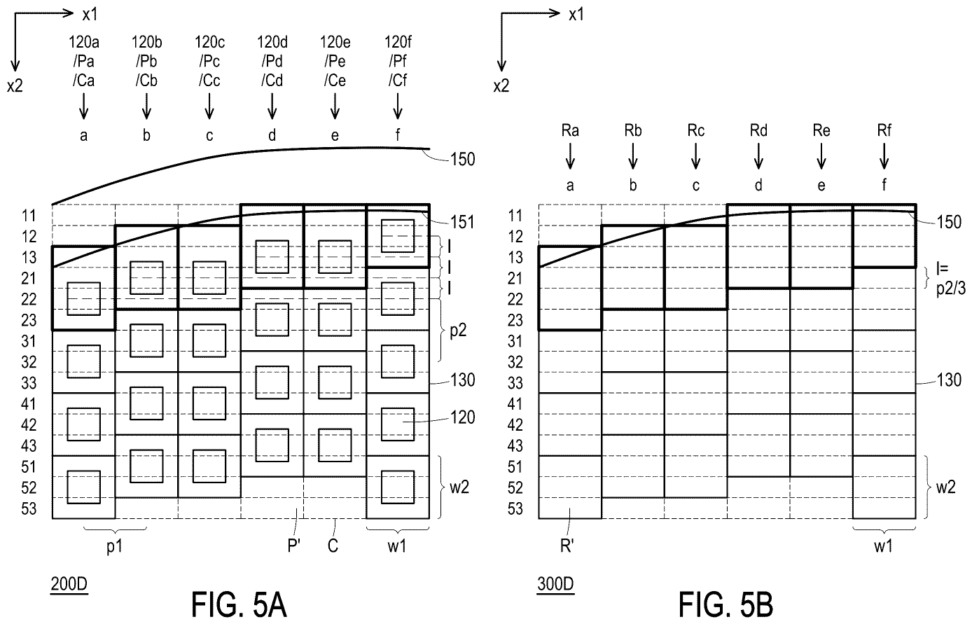

FIG. 5A is a schematic diagram of a light-emitting element array according to an embodiment of the disclosure. FIG. 5B is a schematic diagram of a dimming zone array according to an embodiment of the disclosure.

Referring to FIG. 5A first, in which FIG. 5A is similar to FIG. 4A. The difference is that among the first light-emitting elements in each column, the pixel units corresponding to some of the light-emitting elements are larger in area compared to their corresponding pixel units depicted in FIG. 4A.

Specifically, at least one of the first pixel units in adjacent columns has (n+1) sub-pixel units. That is, at least one of the first pixel units in adjacent columns has increased its pixel unit area.

Taking the light-emitting element array 200D of FIG. 5A as an example, the first light-emitting element of the first column light-emitting element 120a has the coordinates of (a, 22), and its corresponding pixel unit P includes sub-pixel units located at (a, 21), (a, 22), and (a, 23).

In order to position the first pixel unit of the first column pixel unit Pa closer to the boundary 151, this pixel unit is extended upward along the second direction x2 to include the sub-pixel unit P′ located at (a, 13). Therefore, the first pixel unit of the first column pixel unit Pa includes four sub-pixel units located at (a, 13), (a, 21), (a, 22), and (a, 23), that is, (n+1) sub-pixel units (n=3).

The first light-emitting element of the second column light-emitting element 120b has the coordinates of (b, 21), and its corresponding pixel unit P includes sub-pixel units located at (b, 13), (b, 21), and (b, 22).

In order to position the first pixel unit of the second column pixel unit Pb closer to the boundary 151, this pixel unit is extended upward along the second direction x2 to include the sub-pixel unit P′ located at (b, 12). Therefore, the first pixel unit of the second column pixel unit Pb includes four sub-pixel units located at (b, 12), (b, 13), (b, 21), and (b, 22), that is, (n+1) sub-pixel units (n=3).

Since the length of each sub-pixel unit along the second direction x2 is an offset distance l=p2/3, the length of the new pixel unit corresponding to the first light-emitting element of the first column light-emitting element 120a and the second column light-emitting element 120b along the second direction x2 is the second pitch p2 plus the offset distance l=p2/3, that is, 4/3*p2.

According to a similar method, the pixel units of the first light-emitting elements of the remaining columns are adjusted. The first pixel unit of the third column pixel unit Pc includes four sub-pixel units located at (c, 12), (c, 13), (c, 21), and (c, 22). The first pixel unit of the fourth column pixel unit Pd includes four sub-pixel units located at (d, 11), (d, 12), (d, 13), and (d, 21). The first pixel unit of the fifth column pixel unit Pe includes four sub-pixel units located at (e, 11), (e, 12), (e, 13), and (e, 21). The pixel unit of the first light-emitting element in the sixth column light-emitting element 120f includes three sub-pixel units, namely (f, 11), (f, 12), and (f, 13), which remain unchanged.

As mentioned above, each of the cavities C corresponds to each of the pixel units P respectively. According to a similar method, the size of the cavity C corresponding to the pixel unit of the first light-emitting element in each column is adjusted. At least one of the first cavities C in adjacent columns of cavities corresponds to (n+1) sub-pixel units. That is, at least one of the first cavities C in adjacent columns of cavities has increased its pixel unit area.

Therefore, the first cavity of the first column cavity Ca corresponds to 4 sub-pixel units. The first cavity of the second column cavity Cb corresponds to 4 sub-pixel units. The first cavity of the third column cavity Cc corresponds to 4 sub-pixel units. The first cavity of the fourth column cavity Cd corresponds to 4 sub-pixel units. The first cavity of the fifth column cavity Ce corresponds to 4 sub-pixel units. The first cavity of the sixth column cavity Cf corresponds to 3 sub-pixel units.

Referring to FIG. 5B, as mentioned above, each of the dimming zones R corresponds to each of the pixel units P respectively. The dimming zone array 300D corresponds to the change of the light-emitting element array 200D in FIG. 5A, and the size of the cavity C corresponding to the pixel unit of the first light-emitting element in each column is adjusted. At least one of the first dimming zones R in adjacent columns of dimming zones has (n+1) sub-pixel units. That is, at least one of the first dimming zones R in adjacent columns of dimming zones has increased its pixel unit area.

Therefore, the first dimming zone of the first column dimming zone Ra corresponds to 4 sub-pixel units. The first dimming zone of the second column dimming zone Rb corresponds to 4 sub-pixel units. The first dimming zone of the third column dimming zone Rc corresponds to 4 sub-pixel units. The first dimming zone of the fourth column dimming zone Rd corresponds to 4 sub-pixel units. The first dimming zone R of the fifth column dimming zone Re corresponds to 4 sub-pixel units. The first dimming zone R of the sixth column dimming zone Rf corresponds to 3 sub-pixel units. As shown in FIG. 5A and FIG. 5B, by changing the number of sub-pixel units included in the pixel unit P, cavity C, and dimming zone R corresponding to the first light-emitting element in each column of light-emitting elements 120 in the second direction x2, the illumination range of the light-emitting element 120 located near the boundary 151 may be arranged closer to the boundary 151, thereby improving the illumination effect near the boundary 151 and reducing the occurrence of vignetting and the like.

To sum up, by changing the arrangement of the light-emitting elements, the illumination effect of the adjacent special-shaped display device may be effectively improved.

What is claimed is:

1. A display device, comprising:
a plurality of light-emitting elements, forming a plurality of columns of the light-emitting elements extending along a direction, the columns of the light-emitting elements comprising a first column light-emitting element and a second column light-emitting element adjacent to the first column light-emitting element and offset from each other along the direction by an offset distance,
wherein a distance between the first column light-emitting element and the second column light-emitting element is a first pitch, wherein a spacing between two adjacent light-emitting elements of the first column light-emitting element in the direction is a second pitch;
a plurality of pixel units, wherein each of the pixel units respectively corresponds to each of the light-emitting elements,
wherein a length of each of the pixel units along the direction is the second pitch, each of the pixel units along the direction is divided into n sub-pixel units, and a length of the sub-pixel units along the direction is the offset distance.

2. The display device according to claim 1, wherein a relationship between the offset distance and the second pitch is expressed as d=p2/n, where d is the offset distance, p2 is the second pitch, and n is a positive integer greater than or equal to 2.

3. The display device according to claim 2, wherein n is less than or equal to 5.

4. The display device according to claim 1, wherein the first pitch is greater than the second pitch.

5. The display device according to claim 1, adapted to a transportation vehicle, wherein the transportation vehicle comprises a projection surface having an arc, wherein the first column light-emitting element has a first distance from the projection surface, the second column light-emitting element has a second distance from the projection surface, and the second distance has a difference with the first distance, wherein the difference is less than or equal to the offset distance, wherein the first distance is a distance between a midpoint of a side of the first column light-emitting element facing the projection surface and the projection surface along the direction, and the second distance is a distance between a midpoint of a side of the second column light-emitting element facing the projection surface and the projection surface along the direction.

6. The display device according to claim 1, wherein
a first column pixel unit corresponding to the first column light-emitting element and a second column pixel unit corresponding to the second column light-emitting element are offset from each other in the direction by one sub-pixel unit of the sub-pixel units.

7. The display device according to claim 6, wherein at least one of a first pixel unit of the first column pixel unit and a first pixel unit of the second column pixel unit has (n+1) of the sub-pixel units.

8. The display device according to claim 6, further comprising:
a plurality of cavities, wherein each of the cavities respectively corresponds to each of the pixel units and to n of the sub-pixel units of each of the pixel units,
wherein a first column cavity corresponding to the first column pixel unit and a second column cavity corresponding to the second column pixel unit are offset from each other in the direction by one sub-pixel unit of the sub-pixel units.

9. The display device according to claim 8, wherein at least one of a first cavity of the first column cavity and a first cavity of the second column cavity corresponds to (n+1) of the sub-pixel units.

10. The display device according to claim 1, comprising:
a plurality of dimming zones, wherein each of the dimming zones respectively corresponds to each of the pixel units and to n of the sub-pixel units of each of the pixel units;
a control circuit, electrically connected to the light-emitting elements, configured to control light-emitting states of the light-emitting elements and to control brightness of the dimming zones;
wherein a first column dimming zone corresponding to the first column pixel unit and a second column dimming zone corresponding to the second column pixel unit are offset from each other in the direction by one sub-pixel unit of the sub-pixel units.

11. The display device according to claim 10, wherein at least one of a first dimming zone of the first column dimming zone and a first dimming zone of the second column dimming zone corresponds to (n+1) of the sub-pixel units.

12. A display device, comprising:
a plurality of light-emitting elements, forming a plurality of columns of light-emitting elements arranged in sequence along a first direction and extending in a second direction perpendicular to the first direction, the columns of the light-emitting elements comprising a first column light-emitting element and a second column light-emitting element adjacent to the first column light-emitting element and offset from each other along the second direction by an offset distance,
wherein a distance between the first column light-emitting element and the second column light-emitting element in the first direction is a first pitch, wherein a spacing between two adjacent light-emitting elements of the first column light-emitting element in the second direction is a second pitch;
wherein the offset distance is one-n^{th} of the second pitch, where n is a positive integer greater than or equal to 2.

13. The display device according to claim 12, further comprising:
a plurality of pixel units, wherein each of the pixel units respectively corresponds to each of the light-emitting elements,
wherein a length of each of the pixel units along the second direction is the second pitch, each of the pixel units along the second direction is divided into n sub-pixel units, and a length of the sub-pixel units along the direction is the offset distance.

14. The display device according to claim 13, wherein
a first column pixel unit corresponding to the first column light-emitting element and a second column pixel unit corresponding to the second column light-emitting element are offset from each other in the second direction by one sub-pixel unit of the sub-pixel units.

15. The display device according to claim 14, wherein at least one of a first pixel unit of the first column pixel unit and a first pixel unit of the second column pixel unit has (n+1) of the sub-pixel units.
